(19) United States
(12) Patent Application Publication
(10) Pub. No.: US 2008/0249825 A1
(43) Pub. Date: Oct. 9, 2008

(54) INFORMATION TECHNOLOGY MAINTENANCE SYSTEM FRAMEWORK

(75) Inventors: Vishnuraj Rao Kunjur, Bangalore (IN); Lakshmi Narasimhan Narayanan, West Mambalam Chennai (IN); Raghuttam Joshi, Bangalore (IN); Garima Ganeriwala, Nagpur (Mah) (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 12/054,286

(22) Filed: Mar. 24, 2008

(30) Foreign Application Priority Data
Apr. 5, 2007 (IN) 718/CHE/2007

(51) Int. Cl. G06Q 10/00

(52) U.S. Cl. 705/8; 705/7

(57) ABSTRACT

A strategic framework enables improvements in IT system maintenance by taking IT system information as input and outputting useful metrics and/or proposed modifications to achieve efficiency improvements. The strategic framework also can be described as an IT maintenance system assessment and modification tool. The described framework encompasses strategies for effective IT maintenance and improvement. The framework addresses the effectiveness of IT maintenance by focusing on, for example, technology, operations, human and/or non-human resources, and governance solutions. One or more of these dimensions can be assessed and evaluated, for example, to discover and process useful metric information. From the results of a described IT maintenance system assessment, which provides metrics for evaluating efficiency and improvability of IT maintenance systems, an overall roadmap of solutions can be developed. This can be used to form an end-to-end solution for better IT maintenance and portfolio spending in an organization.

### FIELD

Techniques and tools for measuring and improving information technology system efficiency, such as techniques and tools for assessing and improving information technology maintenance systems, are described.

### BACKGROUND

Generally, software vendors and other information technology (“IT”) product companies address IT maintenance system assessment by capturing an “as-is” state of IT systems and tracking IT resources. Most solutions to IT problems currently available in the market are technical in nature. A common approach is to look for technical solutions to specific IT problems in isolation. Previous efforts have not necessarily resulted in useful metrics for measuring IT costs, finding potential cost savings, measuring IT efficiency, and finding improvement opportunities.

### SUMMARY

In summary, the described techniques and tools form a strategic framework that enables improvements in IT system maintenance by taking IT system information as input and outputting metrics and/or proposed modifications to achieve efficiency improvements. The strategic framework also can be described as an IT maintenance system assessment and modification tool. The described framework encompasses strategies for effective IT maintenance and improvement. The framework addresses the effectiveness of IT maintenance by focusing on, for example, technology, operations, human and/or non-human resources, and governance solutions. One or more of these dimensions can be assessed and evaluated, for example, to discover and process metric information. From the results of a described IT maintenance system assessment, which provides metrics for evaluating efficiency and improvability of IT maintenance systems, an overall roadmap of solutions can be developed. This can be used to form an end-to-end solution for better IT maintenance and portfolio spending in an organization.

In some embodiments of the technologies disclosed herein, a method comprises: receiving a first set of data describing one or more governance aspects of an information technology maintenance system for an associated information technology system; receiving a second set of data describing one or more technological aspects of the information technology maintenance system; receiving a third set of data describing one or more operational aspects of the information technology maintenance system; receiving a fourth set of data describing one or more resource aspects of the information technology maintenance system; providing at least one of the first set of data, the second set of data, the third set of data, and the fourth set of data to an information technology maintenance system expert; and receiving from the expert one or more recommendations for modifying the information technology maintenance system based on at least some of the first, second, third and fourth sets of data. The method can further comprise providing, to a party knowledgeable about the information technology maintenance system, a questionnaire regarding at least one of the first set of data, the second set of data, the third set of data, and the fourth set of data. The method can comprise modifying one or more aspects of the information technology maintenance system based at least in part on the one or more recommendations received from the expert. The expert recommendations can be based at least in part on one or more information technology maintenance system best practices criteria. In further embodiments, the expert recommendations can be based at least in part on a target maturity level of an organization associated with the information technology maintenance system. The one or more resource aspects of the information technology maintenance system can relate to human resources, software resources, and/or hardware resources. The recommendations can be intended to reduce the total cost of operations of the associated information technology system. The recommendations can also be intended to improve the performance of the associated information technology system. The method can further comprise receiving a scorecard describing one or more aspects of a maintenance portfolio used with the associated information technology system.

In further embodiments one or more computer-readable media comprise instructions configured to cause a computer to perform a method comprising: presenting to a user a plurality of questions about an information technology maintenance system having an associated information technology system; receiving from the user responses to the plurality of questions, the responses describing governance aspects of the information technology maintenance system, technological aspects of the information technology maintenance system, operational aspects of the information technology maintenance system, and resource aspects of the information technology maintenance system; and storing the user responses in one or more computer-readable media. The method can further comprise providing the user responses to an information technology system expert. In some embodiments the method further comprises receiving one or more recommendations from the information technology system expert. In further embodiments the expert makes one or more recommendations regarding technology rationalization of the associated information technology system using a software tool.

In additional embodiments a method comprises: a step for defining the scope of an assessment of an information technology maintenance system; performing the assessment by collecting data for organizational aspects of the information technology maintenance system, technological aspects of the information technology maintenance system, operational aspects of the information technology maintenance system, and resource aspects of the information technology maintenance system; a step for providing the collected data to an expert; a step for receiving from the expert one or more recommendations for modifying the information technology maintenance system, the recommendations being based on the collected data; and storing the recommendations in one or more computer-readable media. In some embodiments the expert determines the one or more recommendations according to a method comprising: determining a hypothesis for a characteristic of the information technology maintenance system; evaluating one or more aspects of the information technology maintenance system and, based on the evaluating, selecting an aspect for modification; selecting one or more solution categories for the aspect for modification; and identifying one or more solutions based on the one or more solution categories. The method can further comprise generating a scorecard describing one or more aspects of a maintenance portfolio used with the associated information technology system. The method can additionally comprise developing a change program for the information technology maintenance system based on the one or more recommendations. In particular embodiments performing the assessment comprises calculating an effectiveness index for a maintenance portfolio used with the associated information technology maintenance system.

In further embodiments a method of evaluating and maintaining an information technology system comprises: defining a scope of an assessment of a maintenance system associated with the information technology system; collecting information about the maintenance system, wherein the information describes governance aspects of the maintenance system, technological aspects of the maintenance system, operational aspects of the maintenance system, and resource aspects of the maintenance system; assessing a current portfolio associated with the maintenance system; determining, based at least in part on the assessment of the current portfolio, a revised portfolio associated with the maintenance system; determining a solution hypothesis for the maintenance system; evaluating one or more dimensions of the maintenance system based at least in part on the solution hypothesis; selecting one or more solutions for the solution hypothesis based at least in part on the evaluated one or more dimensions and the collected information about the maintenance system; developing a plan for implementing the one or more solutions and the revised portfolio in the maintenance system; and implementing the developed plan.

### BRIEF DESCRIPTION OF THE DRAWINGS

FIG. 1 shows a block diagram of an embodiment of a framework for evaluating an IT maintenance system.

FIG. 2 shows a block diagram of an embodiment of a method for evaluating an IT maintenance system.

FIG. 3 shows a block diagram of another embodiment of a method for evaluating an IT maintenance system.

FIG. 4 shows a block diagram of an embodiment of a method for planning an assessment of an IT maintenance system.

FIG. 5 shows a block diagram of an embodiment of a method for performing an assessment of an IT maintenance system.

FIG. 6 shows a block diagram of an embodiment of a method for developing recommendations for modifying an IT maintenance system.

FIG. 7 shows a block diagram of an embodiment of a method for implementing recommendations for an IT maintenance system.

FIG. 8 shows a block diagram of an exemplary computing environment for implementing described techniques and tools.

FIG. 9 is a diagram illustrating a generalized computer network arrangement.

FIG. 10 shows an embodiment of a scorecard for describing various IT maintenance portfolio aspects.

### DETAILED DESCRIPTION

Disclosed below are embodiments of IT maintenance system technologies and/or related systems used to maintain one or more IT systems. The embodiments should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” The phrase “and/or” can mean “and,” “or” and “one or more of” the elements described in the sentence. Embodiments described herein are exemplary embodiments of the disclosed technologies unless clearly stated otherwise.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed methods and apparatus can be used in conjunction with other methods and apparatus.

The framework for IT system maintenance described herein is flexible and can be implemented in different ways depending on various factors. The framework is referred to herein as having several exemplary characteristics, but it should be understood that the framework can be implemented such that one or more of the exemplary characteristics are not present or are present in modified form. In general, the framework targets optimization and quality improvement for overall maintenance of an IT system. The framework can use fact-based experiential knowledge and can be context-specific.

The framework can allow organizations to reduce tactical and operational spending and focus on strategic transformation. It can also provide organizations with a differentiated maintenance offering which can lower risk, reduce total cost of ownership and improve quality of service. Exemplary sources of value provided by the framework can include one or more of the following:
Reduced risk and increased business value from application analysis in a maintenance portfolio. The framework can help reduce non-discretionary spending in IT budgets.
Enhanced decision making based on transparency in relationships among business processes, applications and architectural components.
Improved efficiency in allocation of resources. The framework can help organizations create more funding for other investments (e.g., innovation investments) by making maintenance budgeting more predictable.
Better alignment of IT investments with business objectives. The framework can help provide better visibility for IT budgeting.
Better accuracy in evaluating application enhancements and sourcing contracts.
Rationalization of IT investments.
IT delivery excellence.
Cost savings based on analyzing a current IT portfolio from multiple perspectives, which can allow for identification of redundancy and obsolescence.

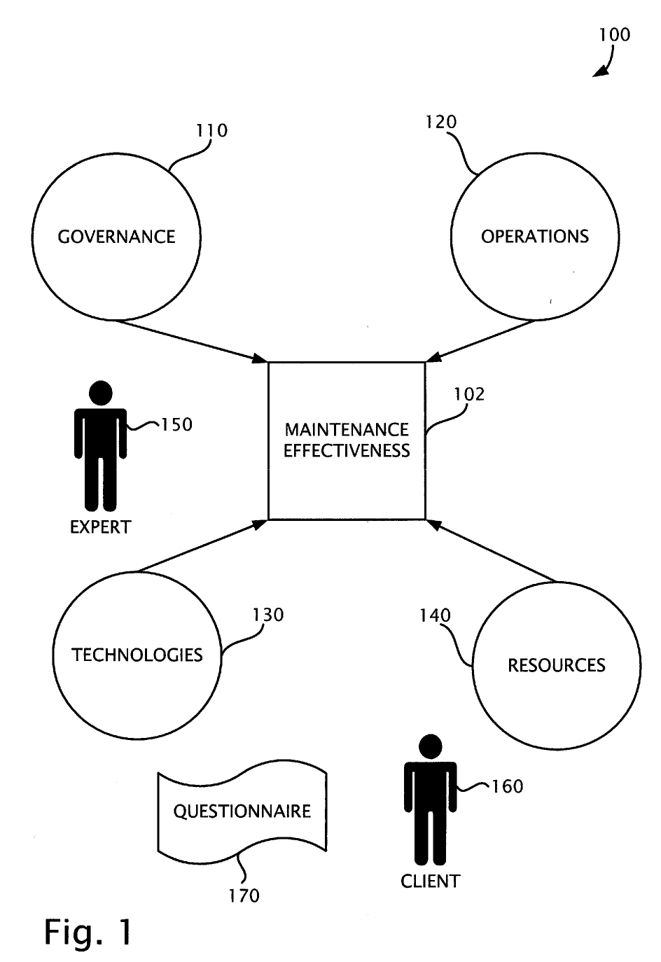

FIG. 1 shows a block diagram 100 of an embodiment of a framework for evaluating an IT maintenance system. In the depicted embodiment, information describing a plurality of dimensions of the IT maintenance system is used in evaluating and/or improving maintenance effectiveness 102. For example, FIG. 1 shows information regarding a system governance dimension 110 (e.g., transparency of system governance), a system operations dimension 120 (e.g., standardization of system operations), a system technologies dimension 130 (e.g., rationalization of system technologies), and a system resources dimension 140 (e.g., consolidation of system resources). Various embodiments of the disclosed technologies utilize information from one or more of the dimensions 110, 120, 130, 140, as well as information from one or more additional dimensions describing the IT maintenance system.

Generally, as used herein: the system governance dimension 110 is directed toward how an IT maintenance system is structured; the system operations dimension 120 is concerned with improving processes used in the maintenance system; the system technologies dimension 130 is directed toward the rationalization of technologies used in the maintenance system; and the system resources dimension 140 is directed toward human resources, hardware resources, and/or software resources in the maintenance system.

In further embodiments, the system governance dimension 110 can deal with, for example: strategic alignment (e.g.: understanding and evaluating an organization's current and prospective business drivers and strategies to determine the organization's alignment; recommending one or more bases for improvement or optimization of design and investment priorities based on the alignment); preventive maintenance (e.g.: using ticket analysis to identify problem trends and taking proactive corrective actions to address the trends; performing a root cause analysis to identify a reason for a failure and/or error; employing user training and other methods of scheduling and governance mechanisms); and organization (e.g.: establishing an understanding of an organization's structure, professional culture, inhibitors and/or enablers; examining roles, responsibilities and/or skills for current and/or future organization states).

In additional embodiments, the system operations dimension 120 can deal with, for example: processes (e.g.: analyzing the extent to which a portfolio and an overall management system are formally defined and measured against a reference model; assessing the effectiveness of an IT service management system by, e.g., examining process ownership, efficiency, effectiveness and consistency of system processes, and the level of automation of the workflows responsible for providing IT-enabled business services); and operational excellence (e.g.: analyzing a system's service support, including incident management, problem management, change management, release management, configuration management, and/or existing service desk process and data; analyzing a system's service delivery, including service level management, availability management, capacity management, financial management, continuity management, and/or security management).

In further embodiments, the system technologies dimension 130 can deal with, for example, finance and business value (e.g., identifying opportunities to improve the IT financial management system to support cost allocation methodologies to, for example, better link investment returns and/or control demand). In particular embodiments the system governance dimension 110 also deals at least in part with finance and business value.

In additional embodiments, the system resources dimension 140 can deal with, for example, demand management (e.g., using a demand management framework which can provide insights as to where costs can be reduced based on a risk reward framework).

By considering one or more of the dimensions 110, 120, 130, 140, at least some embodiments of the disclosed technologies account for one or more aspects of an IT maintenance system such as preventive maintenance, demand management, IT maintenance system processes, human capital, overall alignment of the IT system with business goals and strategies, and portfolio architectural constraints.

Also shown in FIG. 1 are an expert 150, a client 160 and a questionnaire 170. Each of these is described in more detail below.

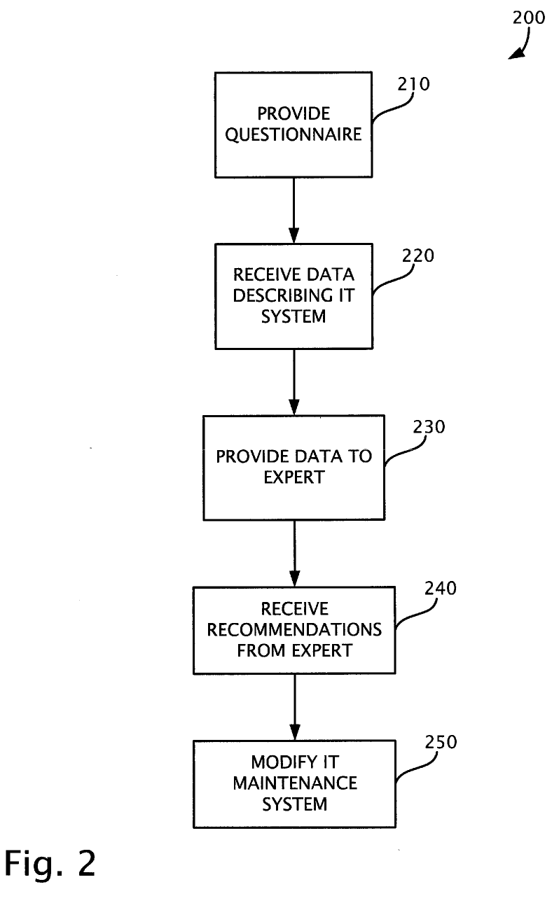

FIG. 2 shows a block diagram of an embodiment of a method 200 for evaluating and maintaining an IT system. In a method act 210 the questionnaire 170 is provided to a client 160, who is generally a party familiar with the IT maintenance system. The client 160 can be, for example, an owner and/or user of the IT system, or someone responsible for maintaining the system. The questionnaire 170 can be provided to the client 160 in a number of forms (e.g., orally, electronically, on paper). Generally, the questionnaire 170 is directed toward obtaining information about the IT maintenance system regarding the dimensions 110, 120, 130, 140 by requesting information about one or more parameters associated with the dimensions. Tables 1-4 below list example parameters for each of the dimensions 110, 120, 130, 140, as well as example questions for the parameters. One or more of these example questions, as well as other questions, can be included in the questionnaire 170.

TABLE 1
Example Parameters and Questions for “Governance” Dimension

| Example Parameter | Example Question for Parameter |
|---|---|
| Communication | Are there dedicated IT-business liaison staff? |
| Policy and Procedures | Are policies and procedures well documented |
| | and implemented? |
| Tools | Do you feel that tool reporting is convenient and |
| | value adding? |
| Budget Prioritization | How IT is budgeted and what is the rationale of |
| | spending? |
| Charge-back Model | Are infrastructure components (assets) mapped |
| | to services and/or business processes they |
| | support? |
| Effectiveness | Do you have a mechanism to assess the overall |
| Scorecard | health of your maintenance spend? |
| Vendor Management | What is the percentage of vendors with service |
| | level agreements (SLAs) in place? |
| Metrics | Do you have a well defined link between IT and |
| | business metrics? |

TABLE 2
Example Parameters and Questions for “Operations” Dimension

| Example Parameter | Example Question for Parameter |
|---|---|
| Six Sigma | Does the process contain and indicate the data |
| | that can be measured pre and post improvement |
| | (e.g., return on investment, cycle time, dollar |
| | benefit)? |
| Center of Excellence | Do you feel that having an edge in a domain can |
| (COE) Setup | help you achieve strategic business advantage |
| | over your competitors? |
| Support Tools | Is turn around time and tracking critical to your |
| | process? |
| Shared Services | Are similar functional applications being |
| | supported in disparate format across various |
| | departments? |
| Incident Management | Is an incident database maintained recording |
| | details for all reported incidents? |
| Problem Management | Is there a procedure for analyzing significant, |
| | recurring and unresolved incidents and |
| | identifying underlying problems? |
| Change Management | Does change management exchange information |
| | with configuration management regarding |
| | change progress and change closure? |
| Service Level | Do you provide management with information |
| Management | concerning trends in service level request? |
| Configuration | Have configuration item naming conventions |
| Management | been established? |
| Service Desk | Do service desk operators have a procedure or |
| | strategy for obtaining the required information |
| | from customers whilst call handling? |
| Availability | Does availability management exchange |
| Management | information with problem management |
| | concerning IT service downtime? |
| Capacity Management | Does the organization have a process to ensure |
| | that there is sufficient capacity to support |
| | planned services? |
| IT Service Continuity | Does IT support center (ITSC) management |
| Management | provide information concerning the IT |
| | contingency plans? |
| IT Security | What is the percentage of delivery cost per |
| Management | customer related to security management |
| | activities? |
| Release Management | Does release management collate information |
| | concerning the number of major and minor |
| | releases within a given period? |

TABLE 3
Example Parameters and Questions for “Resources” Dimension

| Example Parameter | Example Question for Parameter |
|---|---|
| Server Management | Do you have a dedicated team/personnel for |
| | server management? |
| Purchase Order (PO), | Do you maintain a central and updated |
| License, Contract | repository of software licenses? |
| Management | |
| Knowledge Management | Is sharing knowledge learned through projects |
| | part of the standard work process? |
| Sourcing Program | Is a sourcing program a part of the organization |
| | strategy plan? |
| Skills and Expertise | Do you maintain a well documented skills |
| | matrix? |
| Demand Management | Are services documented in a catalog structure |
| | describing the service, SLA and its cost? |
| Asset Management Tools | Do you have a clear picture of the assets |
| | including those held with other providers? |

TABLE 4
Example Parameters and Questions for “Technologies” Dimension

| Example Parameter | Example Question for Parameter |
|---|---|
| Application | What monitoring approach for your line of |
| Availability | business applications can achieve desired |
| | performance and uptime? |
| Application Security | Does the application security in place inspect |
| | application communications or just packets? |
| Technical Currency | Do you have the management intent and the |
| | process to ensure that relevant resources are well |
| | informed about technological developments? |
| Application Scalability | Does your enterprise architecture team maintain |
| | a guide to manage performance and scalability |
| | for the application life cycle? |
| Extensibility | Do you track metrics like time/cost to make a |
| | typical change equal to orchestration-hours of |
| | effort? |
| Complexity | What is the origin of this application? |
| Maintainability | Have you initiated any replacement strategy? |
| Business Criticality | How business critical is the application |
| | especially with respect to strategic significance? |
| Business Value | Which methodology do you use to calculate the |
| | business value? |

Various embodiments of the disclosed technologies use information related to one or more of the parameters shown in Tables 1-4, while further embodiments use information related to additional parameters.

Returning to FIG. 2, in a method act 220, data describing the IT maintenance system is received. The data can include information provided in response to the questionnaire 170, as well as data from additional sources such as existing data. In a method act 230 the data is provided to the expert 150, who is an expert in the field of IT system maintenance. The expert 150 can comprise one person or multiple persons. For the purposes of this application, in some embodiments such an “expert” is someone with qualifications that include, for example, a person with approximately six years or more IT experience with a Master's Degree in Business Administration (or an equivalent degree). In further embodiments, an expert's experience includes approximately 15 to 20 years of IT experience. In particular embodiments, the expert's IT experience includes multiple areas. Such areas can include support, maintenance, IT budgeting, and/or additional areas. In view of the data and the experience of the expert 150, the expert 150 makes one or more recommendations for modifying the IT maintenance system, and these recommendations are received in a method act 240. In some embodiments the recommendations are based in part on one or more industry best practices criteria. The best practices criteria can be based on standards and/or benchmarks such as Control Objectives for Information and related Technology (COBIT), Information Technology Infrastructure Library (ITIL), and Forrester-Gartner. In some cases the best practices criteria are based at least in part on the experience of the expert 150. In further embodiments, the recommendations are based at least in part on a target maturity level of an organization associated with the IT system (e.g., a company for which the IT system provides services). An organization's overall maturity level can be determined (e.g., based on one or more scenarios which describe the maturity of different aspects of the organization) and compared to the target maturity level. Example scenarios can include: the organization's management has an interest in knowledge management, but lacks financial backing for this interest; or the management has both an interest in and financial backing for knowledge management. In these examples, the second scenario can be considered as having a higher maturity level than the first. The expert 150 can employ one or more software tools to aid in developing recommendations.

In further embodiments, the IT maintenance system is modified in accordance with one or more of the expert's recommendations (method act 250). Example modifications for at least some embodiments include, but are not limited to: use of a balanced scorecard for maintenance; asset optimization; Six Sigma-based modifications (e.g., Business Results Impact at Infosys Technologies (BRITE)); ITIL-based modifications; service level agreement/operation level agreement (“SLA/OLA”) setup; and/or global sourcing. An expert's recommendations can comprise a strategic roadmap which looks at critical elements that can contribute to effective running of IT system maintenance in an organization.

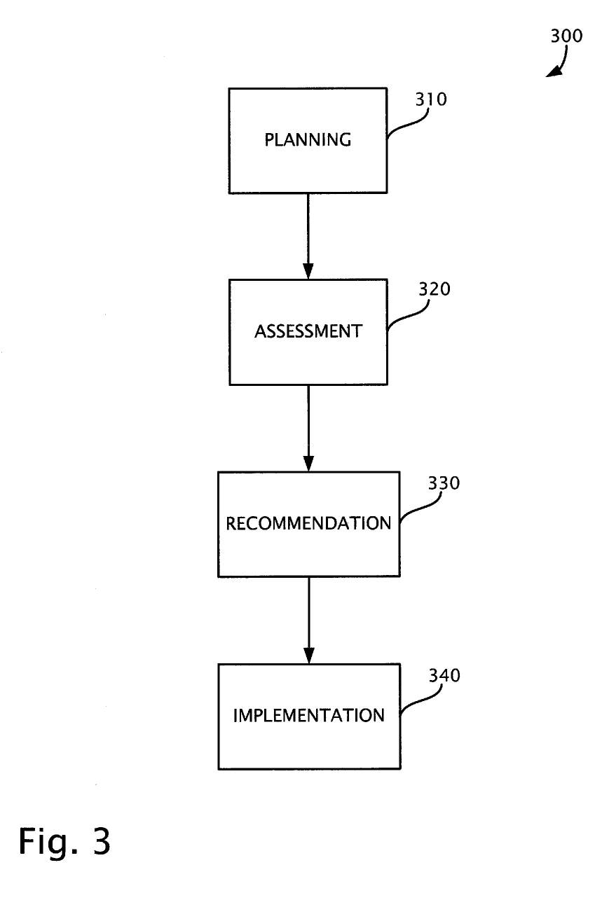

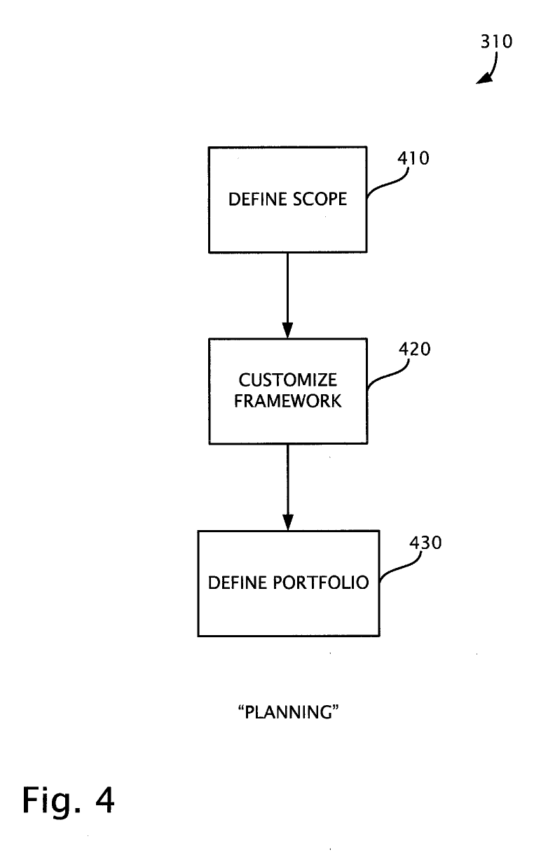

FIG. 3 shows a block diagram of a further embodiment of a method 300 for evaluating and maintaining an IT system. In a method act 310, planning for the assessment of the IT maintenance system is defined. FIG. 4 shows an embodiment of the method act 310. In a method act 410, the scope of the assessment is determined. The assessment scope can be determined based on data and/or goals provided by a client (e.g., a party associated with the IT system). An example assessment scope is “lower the operation costs of the IT system.” The framework is customized according to one or more aspects of the assessment in a method act 420. In some embodiments the framework is customized using a weighted average of a plurality of parameters describing the IT maintenance system. The parameters can be weighted according to a selected priority with respect to the system. One or more portfolios (e.g., software and/or hardware portfolios) are defined in a method act 430. The portfolios can be defined as a group of applications based on, for example, business, technology, region and/or other factors. A score for a given portfolio can be determined at least in part using a weighted average.

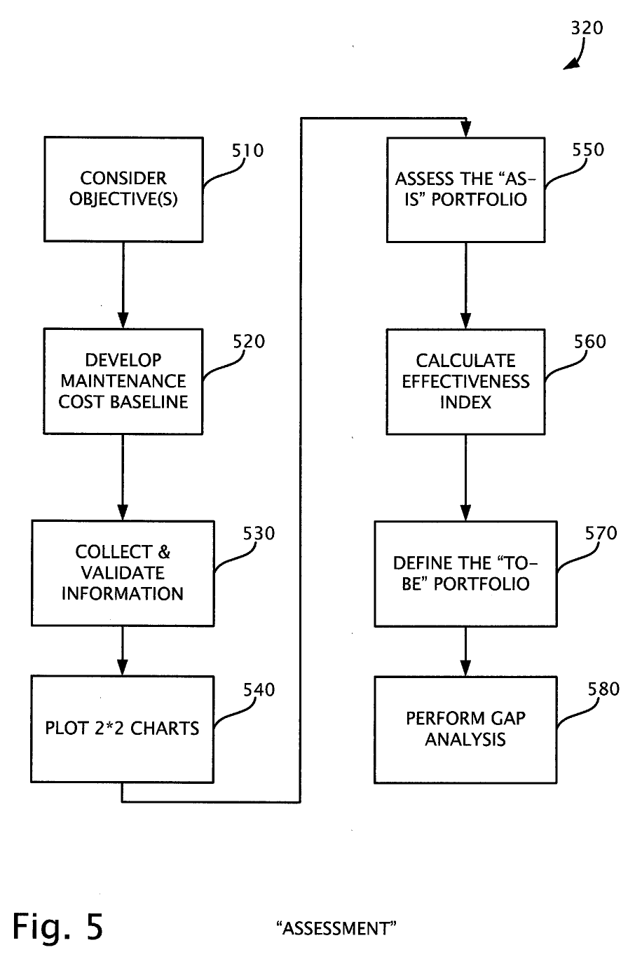

Returning briefly to FIG. 3, in a method act 320, the assessment is performed. The assessment provides for analysis of the portfolio in terms of governance, application/technology health, current operations and infrastructure to produce, for example, an effectiveness index. FIG. 5 shows an embodiment of the method act 320. In a method act 510, one or more objectives of the assessment (e.g., as determined in the method act 310) are considered, and the objectives are used to develop a maintenance cost baseline in a method act 520. The cost baseline can be determined using historical data for the IT maintenance system's budget (e.g., the last three, five, or ten years of the budget). Information about the IT maintenance system is collected and validated in a method act 530 (e.g., using a questionnaire 170 as described above). In at least some embodiments, 2×2 charts are plotted based at least in part on the collected and validated information in a method act 540. The 2×2 charts can show, for example, the performance of a portfolio against parameters such as “maintainability,” “sourcing” and/or other parameters. The current or “As-Is” IT portfolio is assessed in a method act 550. The assessment is created by the expert based on his experience and after considering selected factors which describe the IT maintenance system. For example, factors the expert can consider when assessing portfolio rationalization can include: the business criticality of a particular application; the level of user dependency on an application; and the maintainability of an application. An effectiveness index of the portfolio is calculated in a method act 560. In particular embodiments, the effectiveness index can be calculated based on a plurality of parameters. The parameters can be selected based on the expert's experience, and can include one or more parameters listed above in Tables 1-4, as well as additional parameters. A revised or “To-Be” portfolio can be defined based on the expert's experience in a method act 570, and a gap analysis is performed in a method act 580. In some embodiments the gap analysis is performed using a hypothesis-driven approach, but one or more additional approaches can also be used.

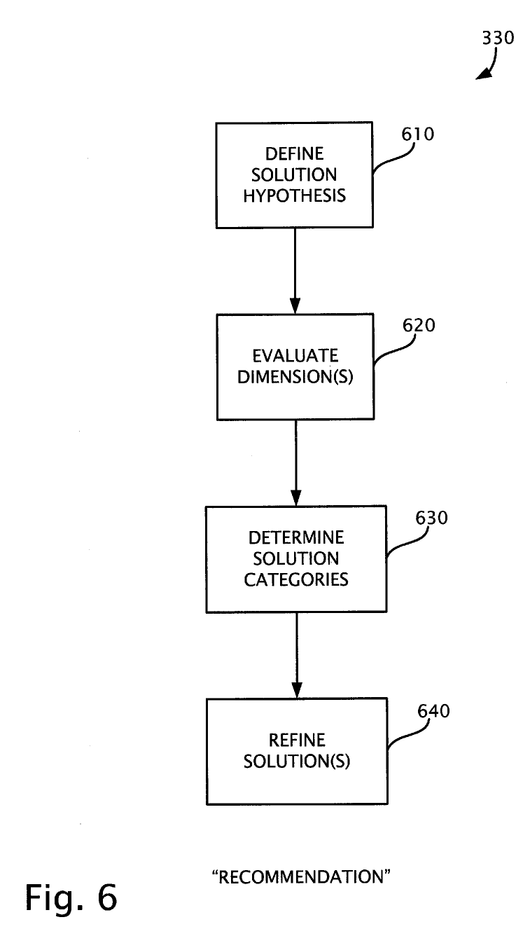

Returning briefly to FIG. 3, in a method act 330 a recommendation is provided (e.g., by the expert 150). The recommendation can include, for example, how to reduce costs, improve performance and enhance the business value of the IT maintenance system. FIG. 6 shows an embodiment of the method act 330. In a method act 610, a solution hypothesis addressing a possible or actual problem with the IT maintenance system is formulated. A sample hypothesis could be, “In a portfolio comprising both legacy custom-built applications and products, there is likely to be a duplication of functionality due to the presence of redundant applications.” In a method act 620, a dimension (e.g., an aspect) of the IT maintenance system is evaluated. For example, a dimension that is evaluated based on the above sample hypothesis could be “Application Effectiveness.” In a method act 630, one or more solution categories are selected based, for example, on the expert's experience. In a method act 640, a list of one or more solutions is created and refined based, for example, on the expert's experience. The method act 640 can include performing a cost/benefit analysis of one or more solutions. Continuing with the example of the foregoing sample hypothesis, solution categories could include: “portfolio analysis” (with corresponding solutions such as “build inventory of applications/components,” “retirement of unnecessary applications/components” and “build As-Is portfolio cost structure”); “application rationalization” (with corresponding solutions such as “identity standard solutions for common problems across business units (BUs),” “licensing rationalization,” “re-engineering/re-platform of applications,” “consolidation of duplicate functionality” and “negotiate additional discounts on software”); “technology rationalization” (with corresponding solutions such as “identify old/redundant technology”); and “business process engineering” (with corresponding solutions such as “categorize the application based on business criticality”).

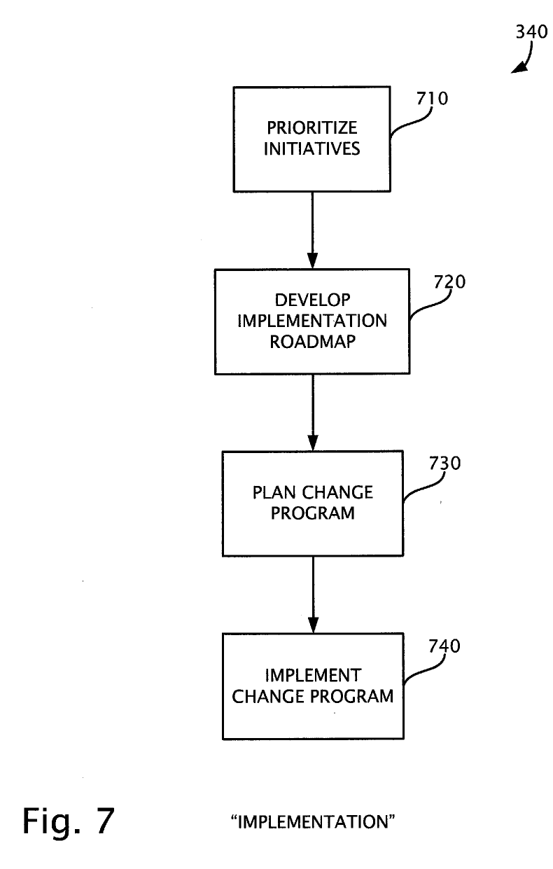

As seen in FIG. 3, one or more recommendations for the IT maintenance system can be implemented in a method act 340. FIG. 7 shows an embodiment of the method act 340. In a method act 710, one or more initiatives based on the recommendations are prioritized, and an implementation roadmap for those initiatives is developed in a method act 720. A change program is planned in a method act 730. In a method act 740, the one or more initiatives are implemented in the IT maintenance system.

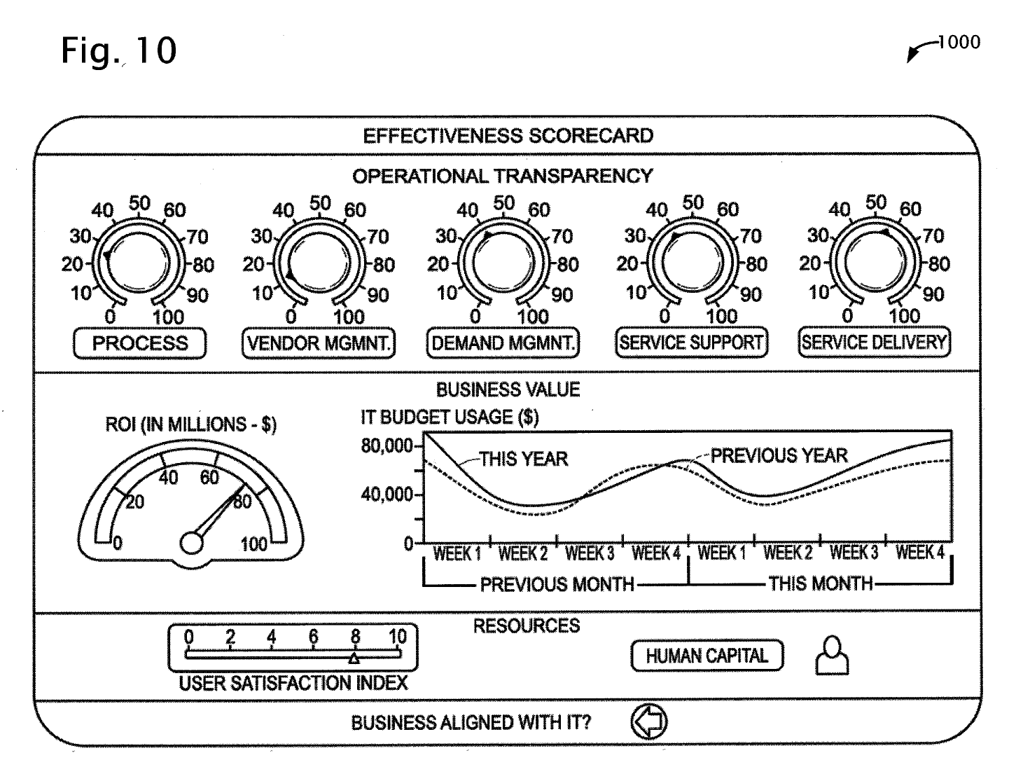

Some embodiments of the disclosed technologies provide a description of one or more aspects of an existing IT maintenance portfolio. For example, FIG. 10 shows an embodiment of a scorecard 1000 which describes various maintenance portfolio aspects (e.g.: the operational transparency of processes, vendor management, demand management, service support and service delivery; return on investment (ROI); human capital; user satisfaction; alignment of the IT system with business objectives; and budget usage) using a numerical score or other indicators. Generally, the scorecard 1000 can aid decision makers who desire a report on returns on IT spending. Such information can, for example, enable decision makers to identify and address problem areas.

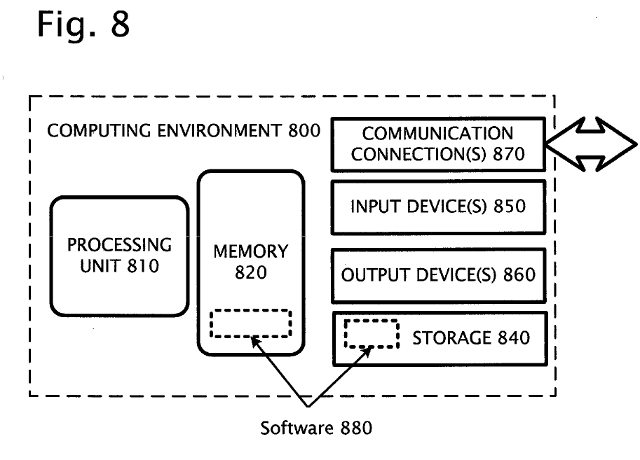

At least one or more portions of one or more of the above-described techniques can be implemented in or can involve one or more computer systems. For example, one or more computer system components (e.g., software and/or hardware components) can be configured to perform one or more method acts described herein. FIG. 8 illustrates a generalized example of a computing environment 800. The computing environment 800 is not intended to suggest any limitation as to scope of use or functionality of the described embodiments.

With reference to FIG. 8, the computing environment 800 includes at least one processing unit 810 and memory 820. The processing unit 810 executes computer-executable instructions and can be a real or a virtual processor. The memory 820 can be volatile memory (e.g., registers, cache, RAM), non-volatile memory (e.g., ROM, EEPROM, flash memory, etc.), or some combination of the two. In some embodiments, the memory 820 stores software 880 implementing described techniques.

A computing environment can have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800 and coordinates activities of the components of the computing environment 800.

The storage 840 can be removable or non-removable, and can include magnetic disks, magnetic tapes or cassettes, CD-ROMs, CD-RWs, DVDs, or any other medium which can be used to store information and which can be accessed within the computing environment 800. In some embodiments, the storage 840 stores instructions for the software 880.

The input device(s) 850 can be a touch input device such as a keyboard, mouse, pen, trackball, touch screen, or game controller, a voice input device, a scanning device, a digital camera, or another device that provides input to the computing environment 800. The output device(s) 860 can comprise a display, printer, speaker, or another device that provides output from the computing environment 800.

The communication connection(s) 870 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 800, computer-readable media include memory 820, storage 840, communication media, and combinations of any of the above.

Implementations can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

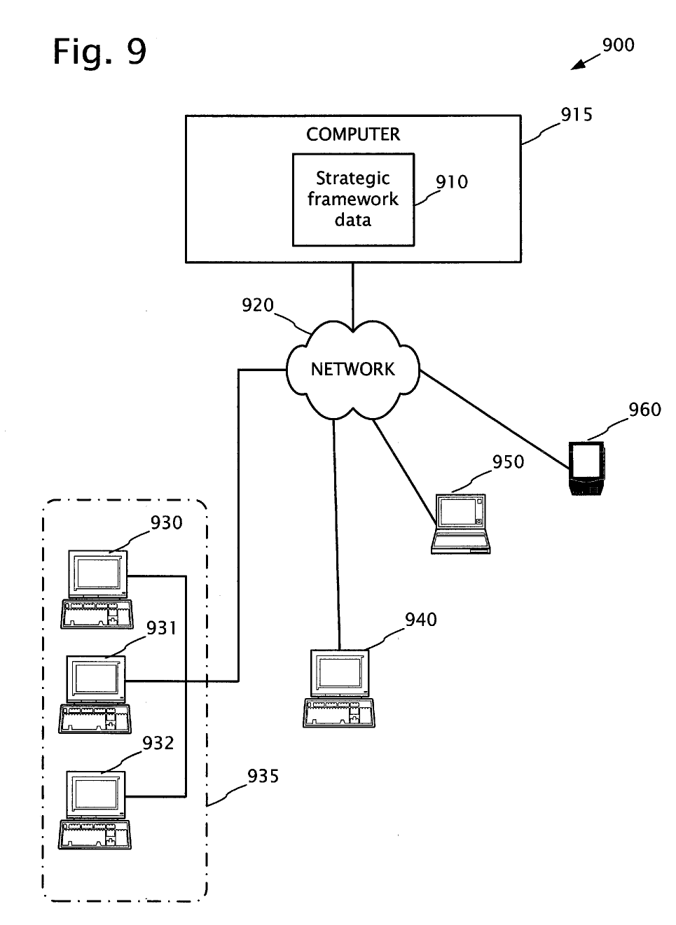

FIG. 9 is an illustration of a generalized network arrangement 900 in which one or more of the described techniques can be implemented, or to which one or more of the described techniques can be applied. FIG. 9 shows an arrangement 900 in which one or more computer users can access strategic framework data 910 at a computer 915 via a network 920. For example, data 910 can include a software tool to perform IT maintenance assessment and modification tasks, and can have access to data from other computers as well. A user can use the tool directly at computer 915, or remotely by connecting to computer 915 and running the tool from the computer 915 (e.g., via a web interface). Or, a user can download the tool and run it locally. For example, the tool can be made available at a web portal for a consulting firm.

A user can access the data 910 from a variety of computing devices connected to network 920 via a wired connection (e.g., via an analog telephone line, DSL connection, broadband cable connection, or some other wired connection), a wireless connection, and/or via some other network. For example, users can access the data 910 via desktop computers 930-932 connected to local network 935, via a computer that is not connected to a local network, such as desktop computer 940, portable laptop computer 950, hand-held computer 960, or some other computing device, such as a device with cellular telephone functionality or other functionality.

Described tools can provide information to a user of the tool regarding IT resources or systems to be analyzed. Described tools can provide upgrade or modification suggestions to a user. Various testing or benchmarking tools can be used to perform or assist in performing certain functions, such as taking inventory of IT resources or testing performance of systems or components.

In view of the many possible embodiments to which the principles of the disclosed technologies may be applied, it should be recognized that the illustrated embodiments are only examples of the technologies and should not be taken as limiting the scope of the invention. Rather, the scope of the invention is defined by the following claims. We therefore claim as our invention all that comes within the scope and spirit of these claims.

We claim:

1. A method comprising:
receiving a first set of data describing one or more governance aspects of an information technology maintenance system for an associated information technology system;
receiving a second set of data describing one or more technological aspects of the information technology maintenance system;
receiving a third set of data describing one or more operational aspects of the information technology maintenance system;
receiving a fourth set of data describing one or more resource aspects of the information technology maintenance system;
providing at least one of the first set of data, the second set of data, the third set of data, and the fourth set of data to an information technology system expert; and
receiving from the expert one or more recommendations for modifying the information technology maintenance system based on at least some of the first, second, third and fourth sets of data.

2. The method of claim 1, further comprising providing, to a party knowledgeable about the information technology maintenance system, a questionnaire regarding at least one of the first set of data, the second set of data, the third set of data, and the fourth set of data.

3. The method of claim 1, further comprising modifying one or more aspects of the information technology maintenance system based at least in part on the one or more recommendations received from the expert.

4. The method of claim 1, wherein the expert recommendations are based at least in part on one or more information technology maintenance system best practices criteria.

5. The method of claim 1, wherein the expert recommendations are based at least in part on a target maturity level of an organization associated with the information technology maintenance system.

6. The method of claim 1, wherein the one or more resource aspects of the information technology maintenance system relate to human resources.

7. The method of claim 1, wherein the one or more resource aspects of the information technology maintenance system relate to software resources.

8. The method of claim 1, wherein the one or more resource aspects of the information technology maintenance system relate to hardware resources.

9. The method of claim 1, wherein the one or more recommendations are intended to reduce the total cost of operations of the associated information technology system.

10. The method of claim 1, wherein the one or more recommendations are intended to improve the performance of the associated information technology system.

11. The method of claim 1, further comprising receiving a scorecard describing one or more aspects of a maintenance portfolio used with the associated information technology system.

12. One or more computer-readable media comprising instructions configured to cause a computer to perform a method comprising:
presenting to a user a plurality of questions about an information technology maintenance system having an associated information technology system;
receiving from the user responses to the plurality of questions, the responses describing governance aspects of the information technology maintenance system, technological aspects of the information technology maintenance system, operational aspects of the information technology maintenance system, and resource aspects of the information technology maintenance system; and
storing the user responses in one or more computer-readable media.

13. The one or more computer-readable media of claim 12, the method further comprising providing the user responses to an information technology system expert.

14. The one or more computer-readable media of claim 13, the method further comprising receiving one or more recommendations from the information technology system expert.

15. A method comprising:
a step for defining the scope of an assessment of an information technology maintenance system;
performing the assessment by collecting data for organizational aspects of the information technology maintenance system, technological aspects of the information technology maintenance system, operational aspects of the information technology maintenance system, and resource aspects of the information technology maintenance system;
a step for providing the collected data to an expert;
a step for receiving from the expert one or more recommendations for modifying the information technology maintenance system, the recommendations being based on the collected data; and
storing the recommendations in one or more computer-readable media.

16. The method of claim 15, wherein the expert determines the one or more recommendations according to a method comprising:
determining a hypothesis for a characteristic of the information technology maintenance system;
evaluating one or more aspects of the information technology maintenance system and, based on the evaluating, selecting an aspect for modification;
selecting one or more solution categories for the aspect for modification; and
identifying one or more solutions based on the one or more solution categories.

17. The method of claim 15, the method further comprising generating a scorecard describing one or more aspects of a maintenance portfolio used with the associated information technology maintenance system.

18. The method of claim 15, the method further comprising developing a change program for the information technology maintenance system based on the one or more recommendations.

19. The method of claim 15, wherein performing the assessment comprises calculating an effectiveness index for a maintenance portfolio used with the associated information technology maintenance system.

20. A method of evaluating and maintaining an information technology system, the method comprising:
defining a scope of an assessment of a maintenance system associated with the information technology system;
collecting information about the maintenance system, wherein the information describes governance aspects of the maintenance system, technological aspects of the maintenance system, operational aspects of the maintenance system, and resource aspects of the maintenance system;
assessing a current portfolio associated with the maintenance system;
determining, based at least in part on the assessment of the current portfolio, a revised portfolio associated with the maintenance system;
determining a solution hypothesis for the maintenance system;
evaluating one or more dimensions of the maintenance system based at least in part on the solution hypothesis;
selecting one or more solutions for the solution hypothesis based at least in part on the evaluated one or more dimensions and the collected information about the maintenance system;
developing a plan for implementing the one or more solutions and the revised portfolio in the maintenance system; and
implementing the developed plan.
